(19) United States
(12) Patent Application Publication
(10) Pub. No.: US 2019/0337349 A1
(43) Pub. Date: Nov. 7, 2019

(54) PNEUMATIC CONTROL SYSTEM FOR VEHICLES AND OTHER LOADED STRUCTURES

(71) Applicant: Hendrickson USA, L.L.C., Itasca, IL (US)

(72) Inventors: Damon Delorenzis, Plainfield, IL (US); Jeff R. Zawacki, Channahon, IL (US); Matthew J. VanMeter, Plainfield, IL (US)

(21) Appl. No.: 16/401,175

(22) Filed: May 2, 2019

Related U.S. Application Data
(60) Provisional application No. 62/667,048, filed on May 4, 2018.

(51) Int. Cl. B60G 17/052; B60G 17/015

(52) U.S. Cl. CPC B60G 17/0525; B60G 17/0155; B60G 2400/252; B60G 2500/302; B60G 2202/152

(57) ABSTRACT

A load isolation device, or suspension assembly of a vehicle, including a damping air spring and a pneumatic control system. The damping air spring is operatively connected to a structure to be isolated and extends from a base operatively connected to or operatively disposed on a source of vibration. The pneumatic control system includes a height control valve connected to the damping air spring and is capable of being actuated between a first operating state and a second operating state. The height control valve enables the damping air spring to maintain the structure at a primary height in the first operating state and at a secondary height different from the primary height in the second operating state.

### CROSS-REFERENCE TO RELATED APPLICATION

This application claims the benefit of U.S. Provisional Application No. 62/667,048, filed May 4, 2018.

### BACKGROUND OF THE INVENTION

### Field of the Invention

The invention relates generally to the art of vehicle air-ride axle/suspension systems, which provide stability to and cushion the ride of a vehicle during operation, and also relates generally to the art of pneumatic control systems for loaded structures. In particular, the invention relates to air-ride axle/suspension systems that utilize pneumatic control systems in conjunction with air springs to control or maintain vehicle ride height. More particularly, the invention relates to a pneumatic control system that utilizes damping air springs in conjunction with a multi-stage height control valve to enable selective improvement of damping and stiffness of the air springs, in order to provide increased ride comfort and/or improved handling for particular road conditions and vehicle operations. The pneumatic control system for improving damping and stiffness of a vehicle, according to the present invention, includes a lowered ride-height state that provides increased damping, increased stiffness, and improved fuel economy and handling dynamics for vehicle operations at high speeds and/or on relatively smooth road surfaces, such as highways, and/or a raised ride-height state that provides decreased damping, decreased stiffness, improved articulation, and increased ground clearance and ride comfort for vehicle operations at slow speeds and/or on bumpy road surfaces, such as city streets or off-highway.

### Background Art

The use of air-ride trailing- and leading-arm rigid beam-type axle/suspension systems has been very popular in the vehicle industry for many years. For the purposes of clarity and convenience, reference is made to a vehicle with the understanding that such reference includes trucks, tractor-trailers or semi-trailers, trailers, and the like. Although air-ride trailing- and leading-arm rigid beam-type axle/suspension systems can be found in widely varying structural forms, in general their structure is similar in that each system typically includes a pair of suspension assemblies. The suspension assemblies are typically connected directly to a primary frame of the vehicle or a subframe supported by the primary frame. For those vehicles that support a subframe, the subframe can be non-movable or movable, the latter being commonly referred to as a slider box, slider subframe, slider undercarriage, secondary slider frame, or bogey.

Typically, each suspension assembly of an air-ride rigid beam-type axle/suspension system includes a pair of longitudinally extending elongated beams. Each beam is typically located adjacent to and below a respective one of a pair of spaced-apart longitudinally extending main members and one or more cross members, which form the frame of the vehicle. For the purpose of convenience and clarity, reference herein will be made to main members with the understanding that such reference is by way of example and includes main members of primary frames, movable subframes, and non-movable subframes. More specifically, each beam is pivotally connected at one of its ends to a hanger, which in turn is attached to and depends from a respective one of the main members of the vehicle. The beam may extend rearwardly or frontwardly from the pivotal connection relative to the front of the vehicle, thus defining what are typically referred to as trailing-arm or leading-arm axle/suspension systems, respectively. For the purposes of the description contained herein, it is understood that the term trailing-arm will encompass beams that extend either rearwardly or frontwardly with respect to the front of the vehicle. An axle extends transversely between and typically is connected by some means to the beams of the pair of suspension assemblies at a selected location from about the mid-point of the beam to the end of the beam opposite from its pivotal connection end. The beam opposite the pivotal connection end also is connected to an air spring, or its equivalent, which in turn is connected to a respective one of the main members. A brake assembly is also mounted on each of the beams and/or axle. A height control valve is mounted on the main member or other support structure of the vehicle and is operatively connected to the beam or axle and to the air spring in order to maintain the ride height of the vehicle.

The axle/suspension system of the vehicle acts to cushion the ride, dampen vibrations, and stabilize the vehicle. More particularly, as the vehicle travels over the road, the wheels of the vehicle encounter road conditions that impart various forces, loads, and/or stresses, collectively referred to herein as forces, to the respective axle on which the wheels are mounted, and, in turn, to the suspension assemblies that are connected to and support the axle. In order to minimize the detrimental effect of these forces on the vehicle as it is operating, the axle/suspension system is designed to react and/or absorb at least some of the forces.

A key component of the axle/suspension system that cushions the ride of the vehicle from vertical impacts is the air spring. Conventional air springs utilized in air-ride axle/suspension systems are typically characterized as either non-damping or damping. A non-damping air spring typically includes three main components: a flexible bellows, a piston, and a bellows top plate. The bellows is formed from rubber or other flexible material, and is operatively mounted on top of the piston. The piston is typically formed from steel, aluminum, fiber reinforced plastics, or other rigid materials, and is mounted on the top plate of the beam of each suspension assembly of the axle/suspension system by fasteners, as is known. The air spring bellows is filled with a volume of pressurized air provided to the air spring via an air tank or air reservoir operatively connected to the air spring and attached to the vehicle. The volume of pressurized air, or “air volume”, that is contained within the air spring is a major factor in determining the spring rate, or stiffness, of the air spring. The greater the air volume of the air spring, the lower the spring rate, or stiffness, of the air spring. During normal vehicle operations on city roads or off-highway, a lower spring rate, or reduced stiffness, is generally more desirable because it provides a softer ride to the vehicle.

Prior art non-damping air springs, while providing cushioning to cargo and occupant(s) during vehicle operation, provide little or no damping to the axle/suspension system. In axle/suspension systems that utilize non-damping air springs, damping characteristics are instead typically provided to the axle/suspension system via one or more hydraulic shock absorbers. The shock absorbers are generally configured to provide damping optimized for operation of the vehicle at a ride height at which the bellows volume of the air spring provides a specific spring rate and stiffness, as is known. Each one of the typical pair of shock absorbers is mounted on and extends between the beam of a respective one of the suspension assemblies of the axle/suspension system and a respective one of the main members of the vehicle. Although shock absorbers provide damping to the axle/suspension system, they undesirably add complexity and weight to the axle/suspension system. In addition, the shock absorbers are a service item of the axle/suspension system that generally requires maintenance and/or replacement from time to time. As a result, the shock absorbers add additional maintenance and/or replacement costs to the axle/suspension system. Moreover, shock absorbers generally provide the same damping characteristic regardless of the vehicle ride height. This is a disadvantage when, for instance, a softer damping characteristic is desired as a vehicle is raised for travel on rough roads, or when a firmer damping characteristic is desired as a vehicle is lowered for travel on smooth roads at higher speeds.

In order to eliminate the need for shock absorbers to provide damping to the vehicle axle/suspension system, air springs with damping characteristics, or damping air springs, such as the one shown and described in U.S. Pat. No. 8,540,222, and assigned to Applicant of the instant application, Hendrickson USA, L.L.C., have been utilized. A damping air spring is typically similar in structure to a non-damping air spring, except that the damping air spring includes a piston chamber incorporating a volume of air that is in fluid communication with the bellows chamber via at least one opening formed in the piston, and providing restricted communication of air between the piston chamber and the bellows chamber during operation of the axle/suspension system.

The restricted communication of air between the piston chamber and the bellows chamber during vehicle operation provides damping to the axle/suspension system. More specifically, when the axle/suspension system experiences a jounce event, such as when the vehicle wheels encounter a curb or a raised bump in the road, the axle moves vertically upwardly toward the vehicle chassis. During such a jounce event, the air spring bellows is compressed by the axle/suspension system as the wheels of the vehicle travel over the curb or the raised bump in the road. The compression of the air spring bellows causes the internal pressure of the bellows to increase. Because the bellows chamber is in fluid communication with the piston chamber via the at least one opening, a pressure differential is created between the bellows chamber and the piston chamber. This pressure differential causes air to flow from the bellows chamber through the opening(s) into the piston chamber. Air continues to flow back and forth through the opening(s) between the bellows chamber and the piston chamber until the pressure of the piston chamber and the bellows chamber have equalized. The restricted flow of air back and forth through the opening(s) causes damping to occur.

Conversely, when the axle/suspension system experiences a rebound event, such as when the vehicle wheels encounter a large hole or depression in the road, the axle moves vertically downwardly away from the vehicle chassis. In such a rebound event, the bellows is expanded by the axle/suspension system as the wheels of the vehicle travel into the hole or depression in the road. The expansion of the air spring bellows causes the internal pressure of the bellows chamber to decrease. As a result, a pressure differential is created between the bellows chamber and the piston chamber. This pressure differential causes air to flow from the piston chamber through the opening(s) into the bellows chamber. Air will continue to flow back and forth through the opening(s) between the bellows chamber and the piston chamber until the pressure of the piston chamber and the bellows chamber have equalized. The restricted flow of air back and forth through the opening(s) causes damping to occur.

Regardless of whether conventional non-damping air springs or damping air springs are utilized, pneumatic control of the air springs is an important feature of air-ride axle/suspension systems. More particularly, maintaining a consistent predetermined distance between the vehicle frame and the travel surface, referred to as a design ride height, is important for cushioning the ride of the vehicle and for optimum performance and longevity of the axle/suspension system. The operating conditions of the vehicle must be considered in order to establish the design ride height of the vehicle. In particular, forces imposed on the axle/suspension system when a vehicle executes certain maneuvers, such as hard turns or traveling over rough terrain, may cause the axle/suspension system to articulate, pivot or rotate, and/or flex beneath the vehicle frame, which the axle/suspension system supports. Typically, an axle/suspension system is designed so that the anticipated range of articulation, pivot or rotation, and/or flexion occurs about a predetermined nominal position that is set as the design ride height of the vehicle.

Articulation, pivot or rotation, and/or flexion of the axle/suspension system can also be caused by the loading and unloading of the vehicle. As a result, after freight is loaded or unloaded from a vehicle, the air springs of the axle/suspension system are typically adjusted to ensure that the vehicle remains at the design ride height. Adjustment of the air springs of the axle/suspension system is typically accomplished by a mechanically operated height control or leveling valve, which is in fluid communication with the vehicle air reservoir and with the air springs, as is known. Adjustments to the height control valve and/or a linkage that controls activation of the valve enables the design ride height to be achieved before the vehicle travels over the road. When the vehicle is loaded with freight, the air springs of the axle/suspension system are typically compressed, causing the vehicle frame to be positioned below the design ride height or closer to the travel surface. The height control valve supplies compressed air to the air springs, thereby inflating or extending the air springs and, in turn, allowing the axle/suspension system to raise the vehicle frame up to the design ride height. Conversely, when freight is unloaded from the vehicle, the air springs of the axle/suspension system are typically extended, causing the vehicle frame to be positioned above the design ride height or further away from the travel surface. The height control valve exhausts air from the air springs, thereby deflating or compressing them until the axle/suspension system lowers the vehicle frame down to the design ride height.

In some vehicle applications, it may be desirable to maintain the vehicle, or one or more of the axle/suspension systems, outside of the design ride height. Air-ride axle/suspension systems utilizing pneumatic control systems to enable such control are generally well-known in the art. For example, such pneumatic control systems have been utilized to enable a vehicle operator to under-inflate or over-inflate non-damping air springs to lower or raise the vehicle ride height outside of the design ride height. In addition, such systems have been utilized to enable a vehicle operator to vent or exhaust air from the non-damping air springs of one or more axle/suspension systems in order to provide improved stability of the vehicle in certain situations. Such prior art pneumatic control systems have typically utilized one or more electronic controllers, solenoid valves, pilot valves, vents, and/or additional pneumatic lines or conduits incorporated into the pneumatic control system to enable the height control valve to maintain one or more of the vehicle axle/suspension systems at a secondary ride height outside of the design ride height, as is known.

Prior art pneumatic control systems, while allowing the axle/suspension system to maintain the vehicle at a secondary ride height outside of the design ride height, have disadvantages, drawbacks, and limitations. For example, prior art pneumatic control systems have been utilized in conjunction with non-damping air springs. Such prior art pneumatic control systems are not configured to improve vehicle damping and stiffness for a particular road condition because such systems generally utilize shock absorbers. Shock absorbers, as described above, are discrete components tuned to provide damping optimized for a particular air spring stiffness. If the air spring stiffness is changed, such as when the air spring is inflated or deflated to increase or decrease, respectively, the ride height outside the design ride height, the shock absorbers may provide non-optimal or insufficient damping for such conditions. In particular, the shock absorber may provide an undesirably low damping energy for an air spring deflated to a ride height lower than the design ride height where an increased damping energy would be desirable for the increased air spring stiffness. Conversely, the shock absorber may provide undesirably high damping energy for an air spring inflated to a ride height higher than the design ride height where a reduced damping energy would be desirable for the decreased air spring stiffness. As a result, the vehicle may have a less comfortable ride and/or reduced handling stability at a ride height outside the design ride height during vehicle operation.

Thus, a need exists for a suspension assembly for vehicles with a pneumatic control system that provides damping and stiffness capable of being selectively optimized for particular road conditions and/or vehicle operations to provide increased ride comfort, improved handling stability, and/or improved energy efficiency. The pneumatic control system for improving damping and stiffness, according to the present invention, satisfies this need by utilizing damping air springs in conjunction with a multi-stage height control valve to provide a raised ride-height state outside the design ride height with improved damping and stiffness for vehicle operation at slow speeds, such as off-highway use, and/or on bumpy road surfaces, such as on city streets. The pneumatic control system for improving damping and stiffness, according to the present invention, utilizes damping air springs in conjunction with a multi-stage height control valve to also provide a lowered ride-height state outside the design ride height with improved damping and stiffness for vehicle operation at high speeds and/or on relatively smooth road surfaces, such as highways, and with reduced aerodynamic drag associated with air moving under the vehicle during forward motion, reducing fuel consumption and improving energy efficiency of the heavy duty-vehicle, thereby reducing the operational costs and the cost of goods transported by the vehicle.

### SUMMARY OF THE INVENTION

Objectives of the present invention include providing a pneumatic control system for a vehicle that exhibits optimized damping and stiffness for particular road conditions encountered by the vehicle during operation.

A further objective of the present invention is to provide a pneumatic control system for a vehicle that exhibits increased ground clearance, improved articulation, and improved ride comfort at slow speeds and/or on bumpy road surfaces.

Yet another objective of the present invention is to provide a pneumatic control system for a vehicle that exhibits improved fuel economy and handling dynamics during vehicle operation at high speeds, thereby reducing operational costs and the cost of goods transported by the vehicle.

These objectives and advantages are obtained by the load isolation device of the present invention which includes a damping air spring operatively connected to a structure to be isolated and extending from a base operatively connected to or operatively disposed on a source of vibration; and a pneumatic control system. The pneumatic control system has a height control valve operatively connected to the damping air spring and the pneumatic control system is capable of being actuated between a first operating state and a second operating state. The height control valve enables the damping air spring to maintain the structure at a primary height in the first operating state and at a secondary height different from the primary height in the second operating state.

### BRIEF DESCRIPTION OF THE SEVERAL VIEWS OF THE DRAWINGS

The preferred embodiments of the present invention, illustrative of the best mode in which applicant has contemplated applying the principles, is set forth in the following description, shown in the drawings, and particularly and distinctly pointed out and set forth in the appended claims.

FIG. 1 is a fragmentary elevational view, partially in section, of an axle/suspension system showing a suspension assembly depending from a vehicle main member, and incorporating a first exemplary embodiment pneumatic control system of the present invention with a multi-stage height control valve mounted on the suspension assembly and operatively connected to the damping air spring;

FIG. 2 is a perspective view, in section, of a damping air spring of the first exemplary embodiment pneumatic control system shown in FIG. 1, showing the bellows chamber in fluid communication with the piston chamber via a pair of openings;

FIG. 3 is a schematic view of the first exemplary embodiment pneumatic control system shown in FIG. 1;

FIG. 4 is an enlarged elevational view of the multi-stage height control valve shown in FIG. 1, showing a control arm in various positions represented by broken lines and arrows;

FIG. 5 is a schematic view of a second exemplary embodiment pneumatic control system of the present invention;

FIG. 6 is an enlarged elevational view of the multi-stage height control valve shown in FIG. 5, showing the control arm in various positions represented by broken lines and arrows;

FIG. 7 is an elevational schematic view of the axle/suspension system shown in FIG. 1, showing the beam and axle at the vehicle design ride height and at the secondary ride-height states with the secondary ride height states represented by broken lines; and

FIG. 8 is a graph showing the relationship between vehicle ride height reduction, vehicle load, and damping energy of damping air springs.

Similar reference characters refer to similar parts throughout.

### DESCRIPTION OF THE PREFERRED EMBODIMENT

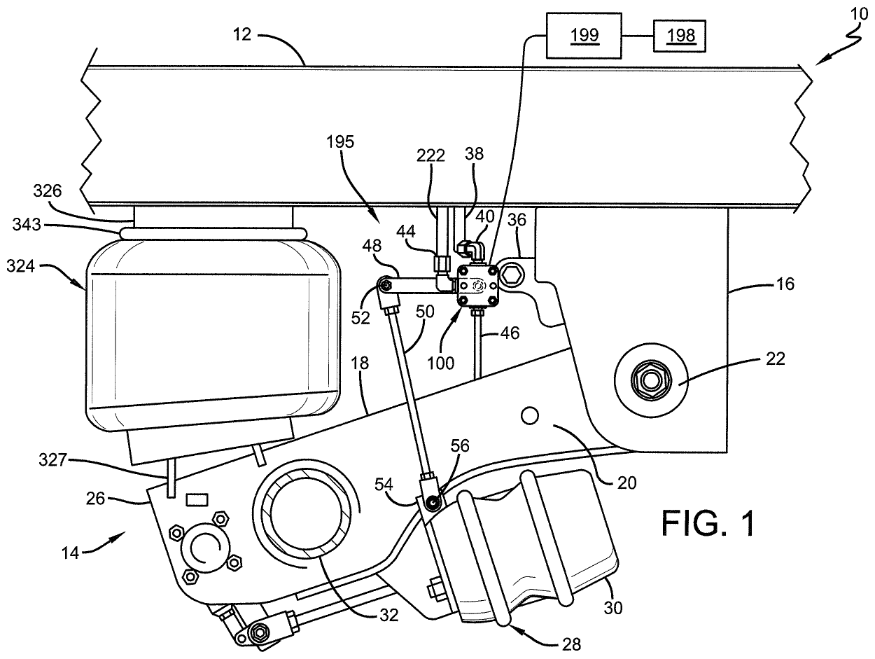

A first exemplary embodiment pneumatic control system 195 for improving damping and stiffness, according to the present invention, is shown in FIGS. 1-4 utilized in conjunction with an axle/suspension system 10 (FIG. 1) for vehicles. Axle/suspension system 10 includes a pair of generally identical suspension assemblies 14 (only one shown), each suspended from a respective one of a pair of transversely spaced hangers 16 (only one shown). Each hanger 16 is secured to and depends from a respective main member 12 of the vehicle. Because suspension assemblies 14 and hangers 16 are generally mirror images of one another, and for the purpose of conciseness, only a single suspension assembly 14 and hanger 16 are shown and described.

Suspension assembly 14 includes a beam 18 that is pivotally mounted at a front end 20 to hanger 16 via a bushing assembly 22 in a known manner. An air spring 324, the function and structure of which will be described in detail below, is suitably mounted on and extends between the upper surface of a rear end 26 of beam 18 and main member 12. For completeness, suspension assembly 14 is shown with components of an air brake system 28, including an air brake chamber 30, attached to beam 18 by way of example. It is to be understood that other arrangements for attaching components of air brake system 28 to axle/suspension system 10 are known in the art. An axle 32 extends between and is captured by beam 18. One or more wheels (not shown) are mounted on each end of axle 32 in a known manner.

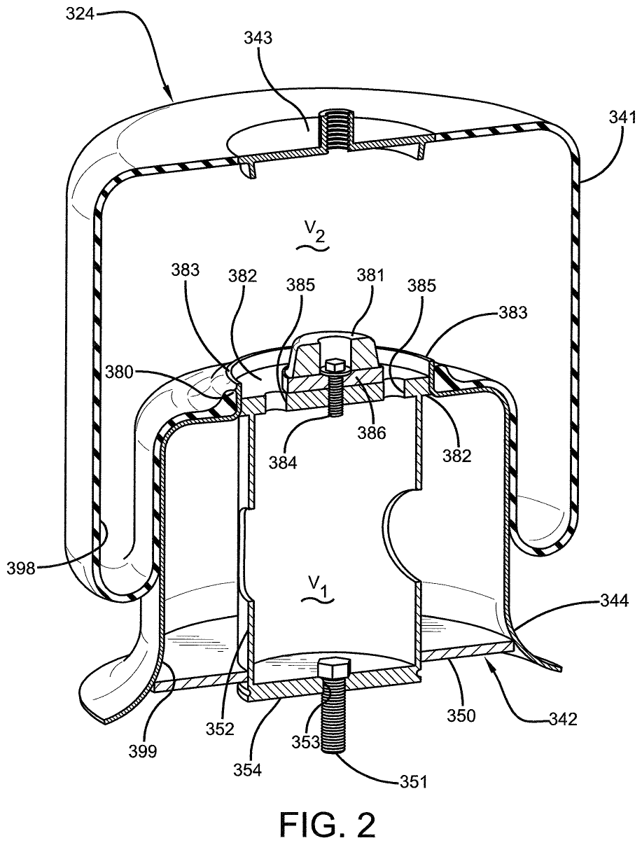

Turning now to FIG. 2, air spring 324 is a damping air spring, such as the type shown and described in U.S. Pat. No. 8,540,222, assigned to Applicant of the present invention, Hendrickson USA, L.L.C. Air spring 324 includes a bellows 341 and a piston 342. The top end of bellows 341 is sealingly engaged with a bellows top plate 343 in a manner well-known in the art. An air spring mounting plate 326 (FIG. 1) is mounted on the top surface of bellows top plate 343 by fasteners (not shown) which are also used to mount the top portion of damping air spring 324 to a respective one of main members 12 of the vehicle. Alternatively, bellows top plate 343 can also be mounted directly to a respective one of main members 12 of the vehicle.

Piston 342 is generally cylindrical-shaped and includes a continuous generally stepped sidewall 344 attached to a generally flat bottom plate 350 and integrally formed with a top plate 382. Bottom plate 350 is formed with an upwardly-extending central hub 352. Central hub 352 includes a bottom plate 354 formed with a central opening 353. A fastener 351 is disposed through central opening 353 in order to attach piston 342 to a pedestal 327 (FIG. 1) that is in turn attached to beam 18 (FIG. 1) near beam rear end 26. Piston top plate 382, stepped sidewall 344, and bottom plate 350 of piston 342 define a piston chamber 399 having an interior volume V₁. Top plate 382 of piston 342 is formed with a circular upwardly-extending protrusion 383 having a lip 380 formed around its circumference. Lip 380 cooperates with the lowermost end of bellows 341 to form an air-tight seal between the bellows and the lip, as is known. Bellows 341, bellows top plate 343, and piston top plate 382 define a bellows chamber 398 having an interior volume V₂.

A bumper 381 is rigidly attached to a bumper mounting plate 386 by means generally well-known in the art. Bumper mounting plate 386 is in turn mounted on piston top plate 382 by a fastener 384. Bumper 381 extends upwardly from the top surface of bumper mounting plate 386. Bumper 381 serves as a cushion between piston top plate 382 and bellows top plate 343 in order to keep the plates from contacting one another, which can potentially cause damage to the plates during air loss or extreme jounce events during operation of the vehicle. A pair of openings 385 is formed in piston top plate 382. Openings 385 allow fluid communication between bellows chamber 398 and piston chamber 399 during operation of the vehicle in order to provide damping characteristics to air spring 324.

When axle 32 of axle/suspension system 10 experiences a jounce event, such as when the vehicle wheels encounter a curb or a raised bump in the road, the axle moves vertically upwardly toward the vehicle chassis. In such a jounce event, bellows chamber 398 is compressed by axle/suspension system 10 as the wheels of the vehicle travel over the curb or the raised bump in the road. The compression of air spring bellows chamber 398 causes the internal pressure of the bellows chamber to increase. Therefore, a pressure differential is created between bellows chamber 398 and piston chamber 399. This pressure differential causes air to flow from bellows chamber 398, through piston top plate openings 385 and into piston chamber 399. The restricted flow of air between bellows chamber 398 into piston chamber 399 through piston top plate openings 385 causes damping to occur in a known manner. Air continues to flow through piston top plate openings 385, reducing the pressure differential between bellows chamber 398 and piston chamber 399 until the pressures of the piston chamber and the bellows chamber have equalized.

Conversely, when axle 32 of axle/suspension system 10 experiences a rebound event, such as when the vehicle wheels encounter a large hole or depression in the road, the axle moves vertically downwardly away from the vehicle chassis. In such a rebound event, bellows chamber 398 is expanded by axle/suspension system 10 as the wheels of the vehicle travel into the hole or depression in the road. The expansion of air spring bellows chamber 398 causes the internal pressure of the bellows chamber to decrease. As a result, a pressure differential is created between bellows chamber 398 and piston chamber 399. This pressure differential causes air to flow from piston chamber 399, through piston top plate openings 385, and into bellows chamber 398. The restricted flow of air through piston top plate openings 385 causes damping to occur in a known manner. Air will continue to flow through the piston top plate openings 385, reducing the pressure differential between bellows chamber 398 and piston chamber 399 until the pressures of the piston chamber and the bellows chamber have equalized.

With reference to FIGS. 1 and 3-4, first exemplary embodiment pneumatic control system 195 includes a multi-stage height control valve 100 of a type known in the art, such as that shown and described in U.S. Pat. No. 8,047,551, assigned to Applicant of the present application, Hendrickson USA, L.L.C. Multi-stage height control valve 100 provides ride height control to axle/suspension system 10, as described below. Multi-stage height control valve 100 is mounted on hanger 16 via a bracket 36 and a secondary spacer (not shown).

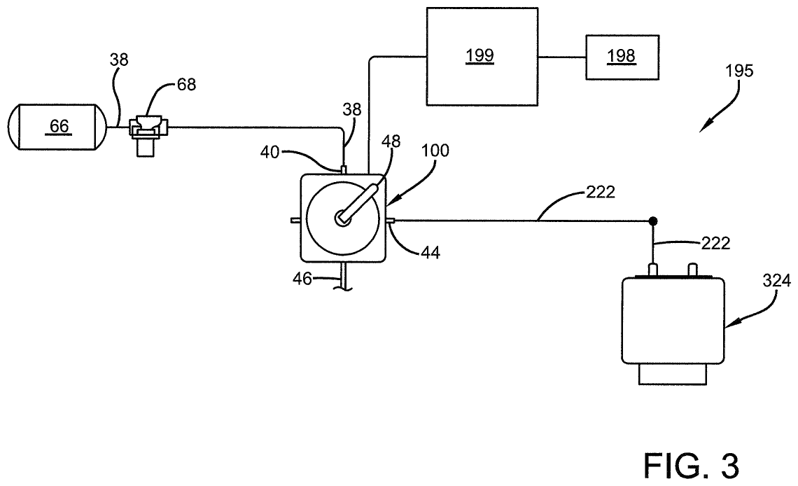

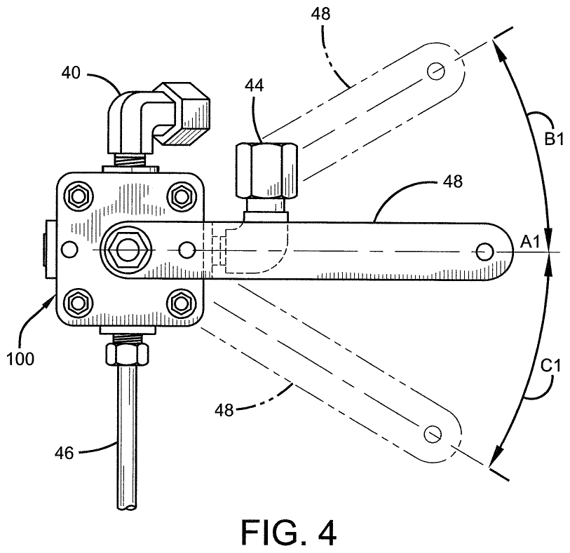

Pneumatic control system 195 also includes an air reservoir conduit 38. Air reservoir conduit 38 is in fluid communication with multi-stage height control valve 100 via an air reservoir fitting 40, and provides compressed air to the height control valve from an air tank or air reservoir 66 (FIG. 3). Pneumatic control system 195 further includes an air spring conduit 222 in fluid communication with multi-stage height control valve 100 via an air spring fitting 44. Air spring conduit 222 is in fluid communication with air spring 324 to enable multi-stage height control valve 100 to route compressed air to and from the air springs based on certain operational conditions, as described below. Pneumatic control system 195 includes an exhaust conduit 46, which is in fluid communication with, and extends from, multi-stage height control valve 100, enabling the height control valve to exhaust compressed air to atmosphere. With particular reference to FIG. 4, pneumatic control system 195 also includes a pressure protection valve 68 disposed between and in fluid communication with air reservoir 66 and multi-stage height control valve 100 via air reservoir conduit 38. Pressure protection valve 68 shuts off the supply of air through air reservoir conduit 38 from air reservoir 66 when the pressure in the air reservoir drops below a pre-determined value, typically 70 psi.

Multi-stage height control valve 100 includes a control arm 48. The position of the control arm 48 regulates the operation of multi-stage height control valve 100. In particular, actuation of control arm 48 between one or more positions, as described below, allows multi-stage height control valve 100 to maintain axle/suspension system 10 at a predetermined height. Moreover, control arm 48 is automatically actuated by a control arm link 50 (FIG. 1), such that the operation of multi-stage height control valve 100 is automatically regulated. Control arm link 50 is pivotally connected at its upper end to control arm 48 via fasteners 52 and at its lower end to beam 18 via a mounting bracket 54 and fasteners 56.

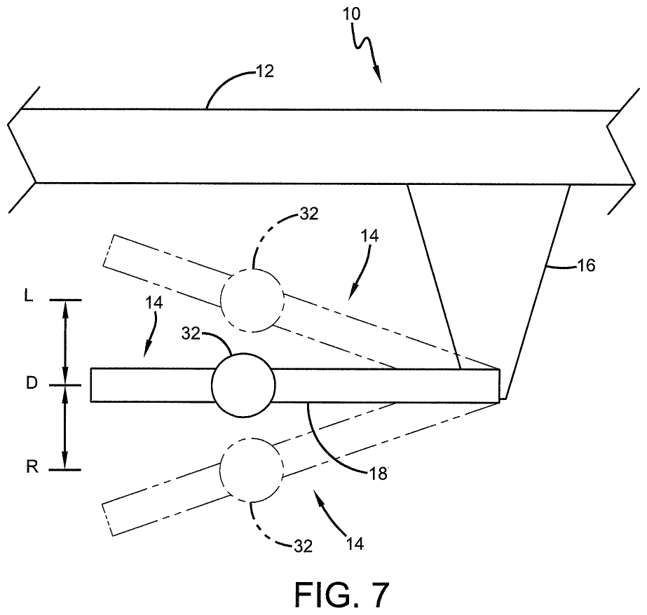

Turning now to FIGS. 4 and 7, during normal vehicle operation, multi-stage height control valve 100 maintains axle/suspension system 10, and thus the vehicle, at a design ride height D. Specifically, at vehicle design ride height D, control arm 48 of multi-stage height control valve 100 is maintained in a neutral position A1. When control arm 48 is at neutral position A1, multi-stage height control valve 100 prevents air from entering or escaping damping air spring 324, and, thus, maintains the volume of compressed air within the air spring at a pre-determined level to maintain axle/suspension system 10, and, thus, the vehicle, at design ride height D. When axle/suspension system 10 articulates to a position that decreases a distance between main member 12 and beam 18, such as when the vehicle is loaded with freight, the ride height is reduced, compressing damping air spring 324. To maintain axle/suspension system 10, and thus the vehicle, at design ride height D when the distance between main member 12 and beam 18 decreases, control arm link 50 moves control arm 48 upwardly from neutral position A1 to a fill position range B1, as shown in FIG. 4, thereby activating multi-stage height control valve 100. Once activated, multi-stage height control valve 100 routes compressed air from air reservoir 66 through air reservoir conduit 38 to damping air spring 324 via air spring conduit 222, inflating the air spring and returning control arm 48 to neutral position A1 and beam 18 of axle/suspension system 10, and thus the vehicle, to design ride height D.

Conversely, when axle/suspension system 10 articulates to a position that increases the distance between main member 12 and beam 18, such as after freight is unloaded from the vehicle, the ride height is increased, extending damping air spring 324. To maintain axle/suspension system 10, and thus the vehicle, at design ride height D, when the distance between main member 12 and beam 18 increases, control arm link 50 moves control arm 48 downwardly from neutral position A1 to an exhaust position range C1, as shown in FIG. 4, thereby activating multi-stage height control valve 100. Once activated, multi-stage height control valve 100 routes compressed air from damping air spring 324 through air spring conduit 222 to exhaust conduit 46, deflating the air spring, which in turn returns control arm 48 to neutral position A1 and beam 18 of axle/suspension system 10, and thus the vehicle, to design ride height D.

In accordance with an important aspect of the present invention, first exemplary embodiment pneumatic control system 195 enables axle/suspension system 10, and thus the vehicle, to be maintained at a secondary lowered ride-height state L (FIG. 7). More specifically, pneumatic control system 195 includes a controller 199, which allows the pneumatic control system to be actuated between an operating state that maintains axle/suspension system 10, and thus the vehicle, at vehicle design ride height D and an operating state that maintains the axle/suspension system, and thus the vehicle, at secondary lowered ride-height state L. Controller 199 could include one or more components known in the art to enable multi-stage height control valve 100 to no longer maintain axle/suspension system 10 at design ride height D and instead to maintain the vehicle at lowered ride-height state L. Controller 199 may be electronic or mechanical/pneumatic and include components such as electronic control units or processors (not shown), regulators (not shown), solenoid valves (not shown), pilot valves (not shown), vents (not shown), and/or additional pneumatic lines or conduits (not shown), or combinations thereof, integrated into pneumatic control system 195. Pneumatic control system 195 includes a switch 198 located within the cab of the vehicle. Alternatively, switch 198 may be located externally of the vehicle cab. Controller 199 of pneumatic control system 195 is operatively connected to switch 198, such that the switch triggers actuation of the pneumatic control system between operating states.

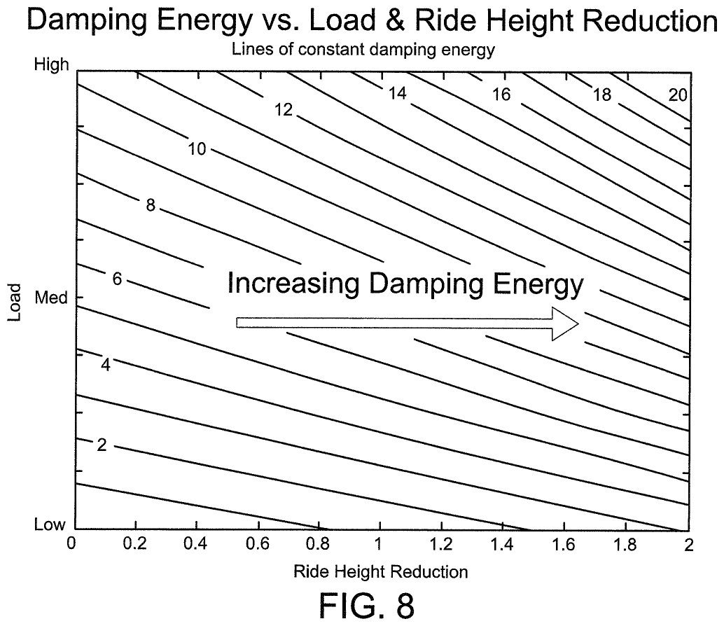

While it is generally desirable to maintain axle/suspension system 10 and the vehicle at design ride height D during normal operation, it may be desirable to lower the vehicle to reduce aerodynamic drag on the vehicle to improve fuel economy during operation at high speeds and/or on smooth roads, such as on highway or interstates. Actuation of the pneumatic control system 195 between operating states by controller 199 allows the vehicle to move between vehicle design ride height D and lowered ride height state L. More specifically, when switch 198 is activated by a vehicle operator, controller 199 actuates pneumatic control system 195 between operating states, enabling multi-stage height control valve 100 to no longer maintain the vehicle at design ride height D (FIG. 7), and, instead, to maintain the vehicle at lowered ride-height state L. It is contemplated that actuation of pneumatic control system 195 between operating states may include altering the length of control arm link 50 to be shorter in order to maintain the vehicle at lowered ride-height state L. Lowered ride height state L decreases the bellows volume within damping air springs 324, which in turn increases the stiffness and damping energy of the damping air springs, as shown in FIG. 8. The increased stiffness and damping energy of damping air springs 324 reduces the roll angle and roll response time, which in turn increases roll stability of axle/suspension system 10. As a result axle/suspension system 10 provides more secure handling at high speeds and/or on relatively smooth road surfaces, such as during highway travel. As described above, the reduced ride-height also decreases drag on the vehicle, improving fuel economy.

When it is desirable for the vehicle to again be maintained at vehicle design ride height D, actuation of the pneumatic control system 195 by controller 199 between operating states allows the vehicle to move between lowered ride height state L and vehicle design ride height D. More specifically, when switch 198 is deactivated, pneumatic control system 195 is actuated between operating states, enabling multi-stage height control valve 100 to maintain axle/suspension system 10, and thus the vehicle, at design ride height D in accordance with the description above.

Thus, pneumatic control system 195 for improving damping and stiffness, according to the present invention, utilizes damping air springs 324 in conjunction with multi-stage height control valve 100 to enable reduced aerodynamic drag, and selectively optimizing damping and stiffness for travel at high speeds and/or on relatively smooth road surfaces, thereby providing reduced fuel consumption, improved energy efficiency, and increased handling stability of the heavy duty-vehicle. The preferred embodiment pneumatic control system 195 is shown utilized in conjunction with vehicle axle/suspension system 10 but may be utilized with any load isolation device or system. In addition, preferred embodiment pneumatic control system 195 is shown utilizing multi-stage height control valve 100 that is mechanical in nature, but could be utilized with any type of electronic multi-stage height control valve and could also utilize an electronic sensor operatively connected between suspension assembly 14 and the height control valve in place of mechanical link 50 in order to actuate the height control valve during vehicle operation.

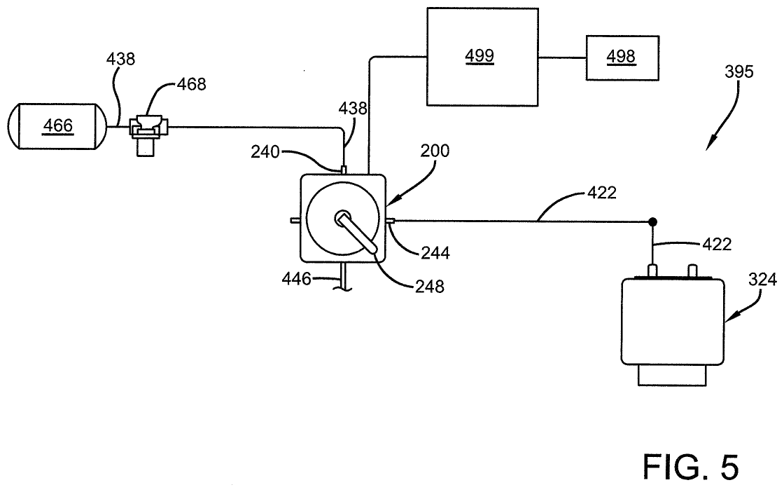

A second exemplary embodiment pneumatic control system 395 (FIG. 5) for improving damping and stiffness, according to the present invention, is utilized in conjunction with a vehicle air-ride axle/suspension system, such as axle/suspension system 10. Pneumatic control system 395 is similar in construction and arrangement to pneumatic control system 195, such that, for the purpose of conciseness, only the differences between the pneumatic control systems will be described below.

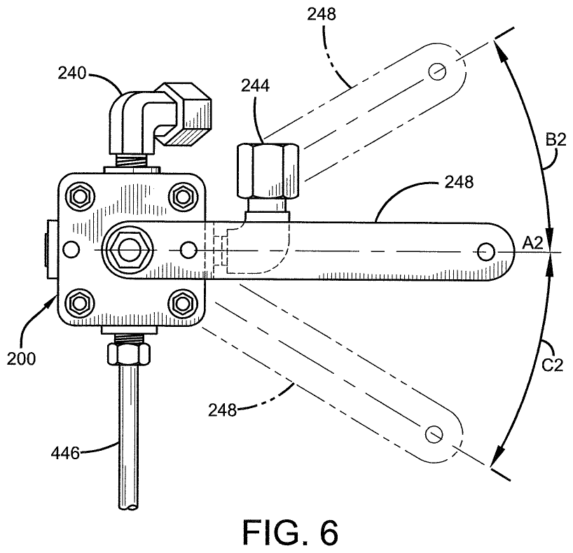

Pneumatic control system 395 includes a multi-stage height control valve 200 (FIGS. 5-6). Multi-stage height control valve 200 of pneumatic control system 395 is similar in construction and function to multi-stage height control valve 100 of pneumatic control system 195. In particular, multi-stage height control valve 200 may be mounted on hanger 16 of axle/suspension system 10 via bracket 36 and a secondary spacer (not shown) and provides control of the ride height of axle/suspension system 10.

Pneumatic control system 395 includes an air reservoir conduit 438 in fluid communication with multi-stage height control valve 200 via an air reservoir fitting 240. Air reservoir conduit 438 provides compressed air to multi-stage height control valve 200 from an air tank or air reservoir 466. Pneumatic control system 395 also includes an air spring conduit 422 in fluid communication with multi-stage height control valve 200 via an air spring fitting 244. Air spring conduit 422 is in fluid communication with air springs 324 to enable multi-stage height control valve 200 to route compressed air to and from the air springs based on certain operational conditions, as described below. Pneumatic control system 395 includes an exhaust conduit 446, which is in fluid communication with, and extends from, multi-stage height control valve 200 to enable the height control valve to exhaust compressed air to atmosphere. Pneumatic control system 395 further includes a pressure protection valve 468 disposed between and in fluid communication with air reservoir 466 and multi-stage height control valve 200 via air reservoir conduit 438. Pressure protection valve 468 selectively blocks the supply of air through air reservoir conduit 438 from air reservoir 466 when the air pressure in the air reservoir drops below a pre-determined value, typically 70 psi.

With continued reference to FIGS. 5-6, multi-stage height control valve 200 includes a control arm 248, the position of which regulates the operation of the multi-stage height control valve. In particular, actuation of control arm 248 between one or more positions, as described in detail below, allows multi-stage height control valve 200 to maintain axle/suspension system 10 at a predetermined height. More specifically, automatic actuation of control arm 248, and, thus, regulation of the operation of multi-stage height control valve 200, may be provided by control arm link 50, the structure and attachment of which are described above with respect to first exemplary embodiment pneumatic control system 195 and which are identical with respect to second exemplary embodiment pneumatic control system 395.

With particular reference to FIGS. 6-7, during normal vehicle operation, multi-stage height control valve 200 maintains axle/suspension system 10, and thus the vehicle, at design ride height D. More specifically, at design ride height D, control arm 248 of multi-stage height control valve 200 is maintained in a neutral position A2. When control arm 248 is at neutral position A2, multi-stage height control valve 200 prevents air from entering or escaping damping air spring 324, and thus maintains the volume of compressed air within the air spring at a pre-determined level to maintain axle/suspension system 10, and thus the vehicle, at design ride height D. When axle/suspension system 10 articulates to a position that decreases a distance between main member 12 and beam 18, such as when the vehicle is loaded with freight, the ride height is reduced, compressing damping air springs 324. To maintain axle/suspension system 10, and thus the vehicle, at design ride height D when the distance between main member 12 and beam 18 decreases, control arm link 50 moves control arm 248 upwardly from neutral position A2 to a fill position range B2, thereby activating multi-stage height control valve 200. Once activated, multi-stage height control valve 200 routes compressed air from air reservoir 466 through air reservoir conduit 438 to damping air spring 324 via air spring conduit 422 and inflates the air spring, returning control arm 248 to neutral position A2 and beam 18 of axle/suspension system 10, and thus the vehicle, to design ride height D.

Conversely, when axle/suspension system 10 articulates to a position that increases the distance between main member 12 and beam 18, such as after freight is unloaded from the vehicle, the ride height is increased, extending damping air spring 324. To maintain axle/suspension system 10, and thus the vehicle, at design ride height when the distance between main member 12 and beam 18 increases, control arm link 50 moves control arm 248 downwardly from neutral position A2 to an exhaust position range C2, thereby activating multi-stage height control valve 200. Once activated, multi-stage height control valve 200 routes compressed air from damping air spring 324 through air spring conduit 422 to exhaust conduit 446, thereby deflating the air spring, which in turn returns control arm 248 to neutral position A2 and beam 18 of axle/suspension system 10, and thus the vehicle, to design ride height D.

In accordance with an important aspect of the present invention, second exemplary embodiment pneumatic control system 395 enables axle/suspension system 10, and thus the vehicle, to be maintained at a secondary raised ride-height state R (FIG. 7). More specifically, and with reference to FIG. 5, pneumatic control system 395 includes a controller 499 allowing the pneumatic control system to be actuated between an operating state that maintains axle/suspension system 10, and thus the vehicle, at vehicle design ride height D and an operating state that maintains the axle/suspension system, and thus the vehicle, at secondary raised ride-height state R. Controller 499 could include one or more components known in the art to enable multi-stage height control valve 200 to no longer maintain axle/suspension system 10 at design ride height D and instead to maintain the vehicle at raised ride-height state R. Controller 499 may be electronic or mechanical/pneumatic and include components such as electronic control units or processors (not shown), solenoid valves (not shown), pilot valves (not shown), vents (not shown), and/or additional pneumatic lines or conduits (not shown), or combinations thereof, integrated into pneumatic control system 395. Pneumatic control system 395 includes a switch 498 located within the cab of the vehicle. Alternatively, switch 498 may be located externally of the vehicle cab. Controller 499 of pneumatic control system 395 is operatively connected to switch 498, such that the switch triggers actuation of the pneumatic control system between operating states.

While it is generally desirable to maintain axle/suspension system 10 and the vehicle at design ride height D during normal operation, it may be desirable to raise the vehicle to improve ground clearance and allow more suspension articulation for greater ride comfort. Actuation of pneumatic control system 395 by controller 499 between operating states allows the vehicle to move between vehicle design ride height D and raised ride height state R. More specifically, when switch 498 is activated by a vehicle operator, controller 499 actuates pneumatic control system 395 between operating states, enabling multi-stage height control valve 200 to no longer maintain the vehicle at design ride height D, and, instead, to maintain the vehicle at raised ride-height state R. It is contemplated that actuation of pneumatic control system 395 between operating states may include altering the length of control arm link 50 to be longer in order to maintain the vehicle at raised ride-height state R. Raised ride height state R increases the bellows volume within damping air springs 324, which in turn decreases the stiffness and damping energy of the air springs, as shown in FIG. 8. The reduced stiffness and damping energy of air springs 324 reduces roll stability of axle/suspension system 10. As a result, axle/suspension system 10 provides increased ground clearance, improved articulation, and improved ride comfort at slow speeds and/or on bumpy road surfaces, such as during travel on city roads or off-highway.

When it is desirable for axle/suspension system 10 and the vehicle to again be maintained at vehicle design ride height D, actuation of the pneumatic control system 395 by controller 499 between operating states allows the vehicle to move between raised ride height state R and vehicle design ride height D. More specifically, when switch 498 is deactivated, pneumatic control system 395 is actuated between operating states, enabling multi-stage height control valve 200 to maintain axle/suspension system 10, and thus the vehicle, at design ride height D in accordance with the description above.

Thus, pneumatic control system 395 for improving damping and stiffness, according to the present invention, utilizes damping air springs 324 in conjunction with multi-stage height control valve 200 to enable damping and stiffness selectively optimized for travel at low speeds and/or on relatively bumpy road surfaces, such as during city or off-highway travel, thereby providing increased ground clearance and articulation of the axle/suspension system and improved ride comfort of the vehicle. The preferred embodiment pneumatic control system 395 is shown utilized in conjunction with vehicle axle/suspension system 10 but may be utilized with any load isolation device or system. In addition, preferred embodiment pneumatic control system 395 is shown utilizing multi-stage height control valve 200 that is mechanical in nature, but could be utilized with any type of electronic multi-stage height control valve and could also utilize an electronic sensor operatively connected between suspension assembly 14 and the height control valve in place of mechanical link 50 in order to actuate the height control valve during vehicle operation. It is to be understood that pneumatic control system 195, 395 of the present invention may include different components and configurations than those shown and described, including multi-stage height control valves with different structures and functions than multi-stage height control valve 100, 200 without affecting the overall concept or operation of the present invention. It is also understood that additional mechanical/pneumatic and/or electronic components known and used in the art, such as electronic control units, regulators, valves, vents, pneumatic lines, and the like, may be used in conjunction with pneumatic control system 195, 395 without affecting the overall concept or operation of the present invention. It is also to be understood that pneumatic control system 195, 395 could utilize damping air springs with structures different from air spring 324 without affecting the overall concept or operation of the present invention. It is contemplated that pneumatic control system 195, 395 could be utilized with a damping air spring that also utilizes a shock absorber without changing the overall concept or operation of the present invention. In addition, it is contemplated that pneumatic control system 195 and pneumatic control system 395 could be integrated into a single vehicle to provide the vehicle with both lowered ride-height state L and raised ride-height state R without affecting the overall concept or operation of the present invention.

It is contemplated that pneumatic control system 195, 395 could be utilized with any load isolation system, and the like, without changing the overall concept or operation of the present invention. It is also contemplated that pneumatic control system 195, 395 could be utilized on tractor-trailers or other heavy-duty vehicles, such as buses, trucks, trailers, and the like, having one or more than one axle without changing the overall concept or operation of the present invention. It is further contemplated that pneumatic control system 195, 395 could be utilized on vehicles having frames or subframes which are moveable or non-movable without changing the overall concept or operation of the present invention.

It is contemplated that pneumatic control system 195, 395 could be utilized on all types of air-ride leading- and/or trailing-arm beam-type axle/suspension system designs known to those skilled in the art without changing the overall concept or operation of the present invention. It is also contemplated that pneumatic control system 195, 395 could be utilized in conjunction with other types of air-ride rigid beam-type axle/suspension systems such as those using U-bolts, U-bolt brackets/axle seats, and the like, without changing the overall concept or operation of the present invention. It is also contemplated that pneumatic control system 195, 395 could be utilized in conjunction with other types of air-ride axle/suspension systems such as spring-beam, non-torque-reactive, independent, four-bag, and the like without changing the overall concept or operation of the present invention. It is further contemplated that pneumatic control system 195, 395 could be utilized with one or more than one axle/suspension system without affecting the overall concept or operation of the present invention.

In the foregoing description, certain terms have been used for brevity, clarity, and understanding; but no unnecessary limitations are to be implied therefrom beyond the requirements of the prior art because such terms are used for descriptive purposes and are intended to be broadly construed. It is to be understood that the structure and arrangements of the above-described pneumatic control system 195, 395 may be altered or rearranged without affecting the overall concept or operation of the invention.

The present invention has been described with reference to specific embodiments. It is to be understood that this description and illustration is by way of example and not by way of limitation. Potential modifications and alterations will occur to others upon a reading and understanding of this disclosure, and it is understood that the invention includes all such modifications and alterations and equivalents thereof.

Accordingly, pneumatic control system 195, 395, according to the present invention, is simplified; provides an effective, safe, inexpensive, and efficient structure and method which achieves all the enumerated objectives; provides for eliminating difficulties encountered with prior art pneumatic control systems; and solves problems and obtains new results in the art.

Having now described the features, discoveries, and principles of the invention, the manner in which pneumatic control system 195, 395 is used and installed, the characteristics of the construction, arrangement, and method steps, and the advantageous new and useful results obtained; the new and useful structures, devices, elements, arrangements, process, parts, and combinations are set forth in the appended claims.

What is claimed is:

1. A load isolation device comprising:
a damping air spring operatively connected to a structure to be isolated and extending from a base operatively connected to or operatively disposed on a source of vibration; and
a pneumatic control system having a height control valve operatively connected to said damping air spring, said pneumatic control system capable of being actuated between a first operating state and a second operating state;
wherein said height control valve enables said damping air spring to maintain said structure at a primary height in said first operating state, and to maintain said structure at a secondary height different from said primary height in said second operating state.

2. The load isolation device of claim 1, the load isolation device being a suspension assembly, wherein the structure is a frame of a vehicle.

3. The load isolation device of claim 2, said pneumatic control system further comprising a controller operatively connected to said pneumatic control system for actuating said pneumatic control system between said first and second operating states.

4. The load isolation device of claim 3, said controller further comprising at least one component selected from the group consisting of an electronic control unit, a solenoid valve, a vent, a pneumatic line, and a pilot valve;
wherein said at least one component is operatively connected to said height control valve and said damping air spring.

5. The load isolation device of claim 4, said controller further comprising a switch disposed within or externally to a cab of said vehicle.

6. The load isolation device of claim 2, said secondary height further comprising a height that is lower than said primary height,
wherein said damping air spring has a damping and stiffness greater than at the primary height.

7. The load isolation device of claim 2, said secondary height further comprising a height that is raised from said primary height,
wherein said damping air spring has a damping and stiffness less than at the primary height.

8. The load isolation device of claim 2, said pneumatic control system further comprising a link operatively connected between said suspension assembly and said height control valve.

9. The load isolation device of claim 8 wherein actuation of said pneumatic control system between said first and second operating states increases or decreases a length of said link.

10. The load isolation device of claim 2, said height control valve further comprising a control arm operatively connected to said link, said control arm including:
a neutral position, wherein said height control valve prevents air from entering or leaving said damping air spring and sustains a volume of air within said damping air spring to maintain said suspension assembly at said primary height or said secondary height;
a fill position, wherein said height control valve allows air from a pressurized source of air to inflate said damping air spring and return said control arm to said neutral position; and
an exhaust position, wherein said height control valve allows air to escape from said damping air spring to deflate said damping air spring and return said control arm to said neutral position.

11. The load isolation device of claim 2, said pneumatic control system capable of being further actuated for a third operating state;
wherein said height control valve enables said damping air spring to maintain said frame of said vehicle at a tertiary height different from said primary height and said secondary height in said third operating state.

12. The load isolation device of claim 11, said secondary height further comprising a height that is lower than said primary height,
wherein said damping air spring has a damping and stiffness greater than at the primary height.

13. The load isolation device of claim 11, said tertiary height further comprising a height that is raised from said primary height,
wherein said damping air spring has a damping and stiffness less than at the primary height.

14. The load isolation device of claim 2, said pneumatic control system further comprising an electronic sensor operatively connected between said suspension assembly and said height control valve.
